(19) United States
(12) Patent Application Publication
(10) Pub. No.: US 2003/0160811 A1
(43) Pub. Date: Aug. 28, 2003

(54) Information stand with an automated e-mail generation

(76) Inventor: Christian Oxholm Zigler, Copenhagen K (DK)

Correspondence Address: JACOBSON HOLMAN PLLC, 400 SEVENTH STREET N.W., SUITE 600, WASHINGTON, DC, 20004, US

(21) Appl. No.: 10/083,632

(22) Filed: Feb. 27, 2002

(51) Int. Cl. G09G 5/00

(52) U.S. Cl. 345/719; 345/752

(57) ABSTRACT

An information stand (100) with an automated e-mail generation comprising a front (101), a proximity sensor (102), a display (103), an input device (104), a multimedia recorder (105) for recording multimedia content, a mail transmitter (106) and a processor (107). The multimedia content can be a video clip or an audio clip. The processor of the information stand is arranged to perform the following steps: detecting the user (108) in the front of the information stand by means of the proximity sensor; presenting a user instruction on the display in response to the detection of the user by the proximity sensor; prompting the user to confirm the user instruction presented by means of the display on the input device; recording the multimedia content of the user by means of the multimedia recorder in response to the confirmation of the user instruction; prompting the user to enter an e-mail recipient address and an own name; generating an e-mail (109), wherein a body of the E-mail comprises a predetermined text, an attachment of the multimedia content recorded, said own name and a first link, wherein the first link refers to a commercial site with promotional material; and sending the E-mail body to the E-mail recipient address by means of the mail transmitter via the Internet (110). The e-mail body can further comprise a link to a player for the multimedia content recorded, wherein this link is determined by the processor in order to make said recorded content playable at a client site of the E-mail recipient.

This invention relates to an information stand with an automated e-mail generation.

The present invention further relates to a computer program product for performing the steps of a method executed on a processor of said information stand.

U.S. Pat. No. 6,085,195 discloses a system of an interactive public kiosk. In the kiosk a user can have an image of him captured, and may subsequently add a thematic background to the image taken, whereby the system modifies the image accordingly. The image can be put into an HTML file with a given URL address. By means of the system the HTML file is uploaded to a server having the URL address. Thereby other users can access the image by means of a given URL address.

However, the above prior art method involves the problem that a user, who also desires to draw attention to an interesting Web site to a friend of his, in addition to sending an image can not perform this action automatically by means of the prior art.

Further, the above prior art method also involves the problem that a company that desires to draw a widely broadcasted attention to a particular interesting Web site, which is already preferred by another mail user, cannot do so with the prior art.

It is therefore an object to provide an apparatus that can take an image of the user or record a sound of the user, where this information—together with a link to an interesting Web site—can automatically be used to promote the visiting of the particular interesting Web site.

It is known to mass distribute e-mails to a great number of users, however, such e-mails are often thrown away unread, since the recipients of such mail consider them uninteresting and in no way targeted at them since they are often sent—seen from the recipients point of view—by an unknown or uninteresting sender.

It is therefore a further object to provide an apparatus that—by means of an e-mail—can generate a mass distributed attention to a link from a sender known of an recipient, wherein the sender recommends a particulary interesting Web site of the link in the e-mail to the recipient.

It is known to receive different kinds of media content in form of an attachment to an e-mail; however, receivers or recipients of such media content are often not able to have the media content presented immediately on their computer, since they do not have the appropriate software program to do so.

It is therefore a further object to provide an apparatus that previously to a sending of an e-mail, generates information how—by means of a certain software program—the media content received can be presented on the computer of the recipient.

The above problem is solved by means of an information stand that comprises a front, a proximity sensor, a display, an input device, a multimedia recorder for recording multimedia content, a mail transmitter and a processor, wherein the processor is coupled to the proximity sensor, the display, the input device, the multimedia recorder and where the processor is arranged to perform the following steps:

detecting the user in the front of the information stand by means of the proximity sensor;

presenting a user instruction on the display in response to the detection of the user by the proximity sensor;

prompting the user to confirm the user instruction presented by means of the display on the input device;

recording the multimedia content of the user by means of the multimedia recorder in response to the confirmation of the user instruction;

prompting the user to enter an e-mail recipient address and an own name;

generating an e-mail, wherein a body of the E-mail comprises a predetermined text, an attachment of the multimedia content recorded, said own name and a first link, wherein the first link refers to a commercial site with promotional material; and

sending the E-mail body to the E-mail recipient address by means of the mail transmitter.

Hereby the information stand can, by means of the first three steps, detect the presence of the user, present to him the user instruction and prompt him to confirm the given instruction.

Subsequently, in the next two steps, the information stand can by means of the processor and the multimedia recorder record the multimedia content such as a video clip or an audio clip of the user.

In the next step the user is prompted to give an address of a receiver known by him, i.e. the e-mail recipient address, and his own name.

By means of the next step, the processor of the information stand can generate an E-mail, which comprises a given text, an attachment of the newly recorded multimedia content, the newly given own name of the user and a link to a commercial site.

Finally, in the last step, the e-mail can be sent from the information stand to said E-mail recipient address.

Hereby, the problem of drawing attention to an interesting Web site, i.e. said link to a commercial site, to a friend of his, i.e. the e-mail recipient address, is solved by means of said mail, when the mail is subsequently being sent.

Hereby, the object of providing an apparatus, i.e. the information stand, that is arranged to capture an image of a user or record a sound of a user, where this information—together with a link to an interesting Web site can automatically be used to promote the viewing of the particular interesting Web site—is solved. It is solved in that said e-mail comprises the information of multimedia content and a link to a commercial site, and, especially when the e-mail also comprises the name of the sender, which will give the e-mail recipient an incentive to open the e-mail, because the e-mail recipient knows the sender of the e-mail. In other words, the receiver of the e-mail will most likely open the e-mail instead of deleting it, and thereby the particular Web site is promoted.

Consequently, this e-mail recipient may send another copy of the e-mail received to other friends, and thereby the further object of providing a apparatus which—by means of the e-mail with said content can provide a widespread attention to a link from a sender known of an recipient, wherein the sender recommends a particular interesting Web site of the link in the email to the recipient—is achieved.

In a preferred embodiment of the information stand, the e-mail body may further comprise a second link to a player for the multimedia content recorded.

Hereby, the object of providing an apparatus that generates information how, by means of a certain software program, the media content received can be presented on the computer of the recipient is achieved. It is achieved in that the information stand generates said second link to a player for the multimedia content recorded embedded in the e-mail, and thereby the media content received (in the e-mail) can be presented on the computer of a recipient.

The invention will be explained more fully below in connection with preferred embodiments and with reference to the drawings, in which:

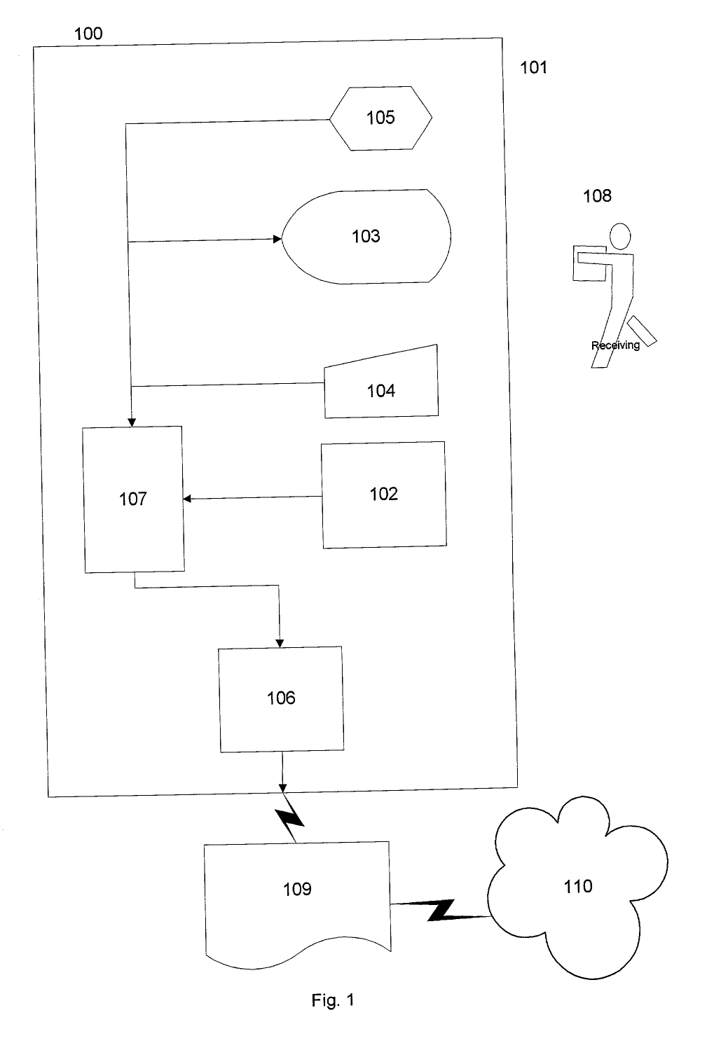

FIG. 1 shows an information stand,

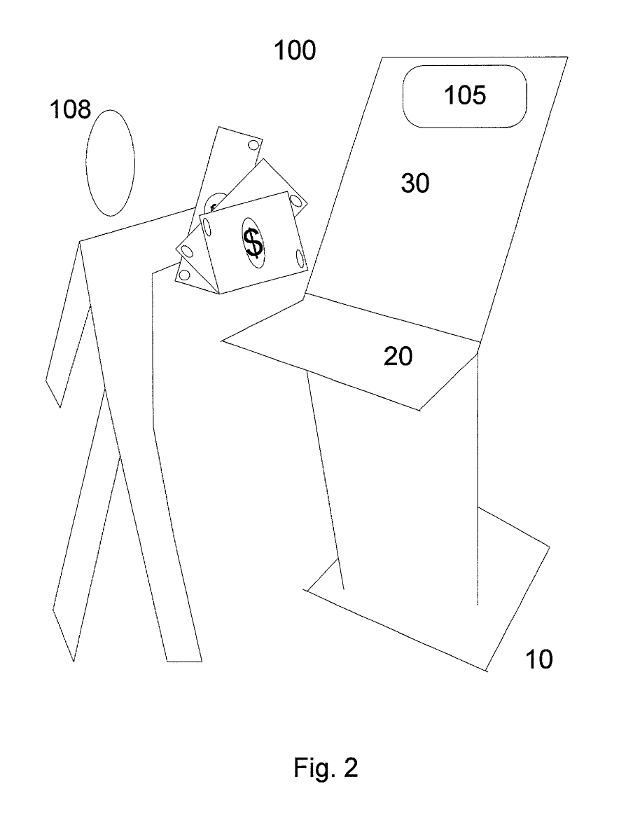

FIG. 2 shows a physical implementation of the information stand, and

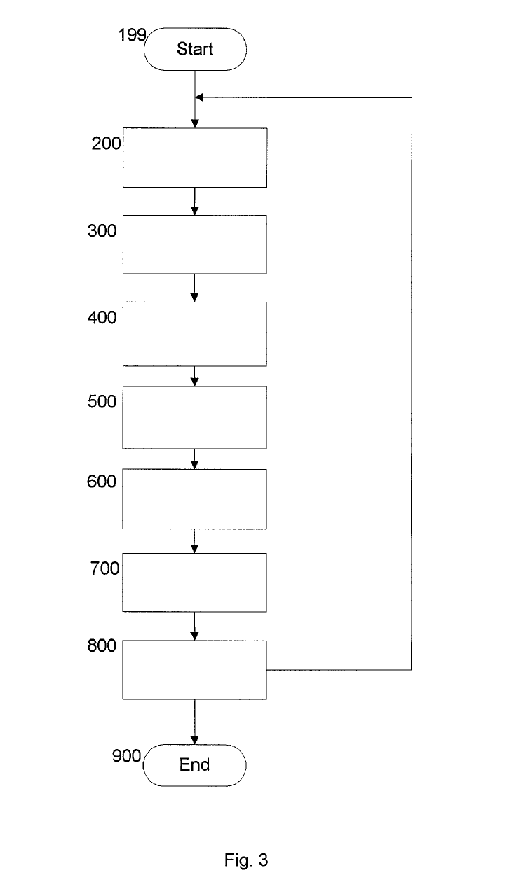

FIG. 3 shows the steps of the processor of the information stand.

FIG. 1 shows an information stand. The information stand as shown by reference numeral 100 has a front as shown by reference numeral 101. In front of said front, a user as indicated by reference numeral 108 may operate the information stand. During the operation of the information stand the user may be detected to be close to the information stand by means of a proximity sensor as indicated by reference numeral 102. The proximity sensor may be any movement sensor as known of the prior art. During the operation of said information stand the user, reference numeral 108, may have various information presented to him on a display as indicated by reference numeral 103. The information may be a user instruction, i.e. how to operate the information stand, it may be an information to confirm the user instruction and further it may be information indicating that a multimedia content of the user is about to be recorded. The multimedia content recorded may be a video clip or an audio clip of the user. The user may respond to the instruction given by means of an input device as shown by reference numeral 104. The input device may be a keyboard and/or fields sensitive to touch on said display. Reference numeral 105 may be a multimedia recorder for recording multimedia content; the multimedia recorder may be using a Web cam, a camera and/or a microphone in order to generate and subsequently record and store said multimedia content. The multimedia content may be a video clip or a clip of audio. Said multimedia content may—by means of the processor—be attached to an e-mail, and in order to send this e-mail to a remote server by means of the Internet, as indicated by reference numeral 110, the information stand of reference numeral 100 may further have a mail transmitter, reference numeral 106 connected to a processor, reference numeral 107. The processor is arranged to receive inputs from the proximity sensor, the display, if it has touch sensitive fields on its front, the input device and the multimedia recorder. The processor, which will be explained in FIG. 3, may then—on basis of said inputs—generate an output in the form of an e-mail to the mail transmitter. A content of said e-mail is indicated by means of reference numeral 109.

FIG. 2 shows a physical implementation of the information stand. Reference numeral 10 is a platform, by use of which the information stand may be operated without being tilted. Reference numeral 20 is a user disk, where upon the input device of reference numeral 104 of the foregoing figure may be positioned. Reference numeral 30 represents the position of the display of reference numeral 103 of the foregoing figure, said display being positioned in the shown angle in order that said user of reference numeral 108 is able to readily watch the information display. The angle of the display is appropriate for the position of a placement of said multimedia recorder, reference numeral 105 from FIG. 1. The multimedia recorder may have its input(s) from a Web cam, a camera or a microphone, or from the combination thereof. Said information stand is designed to contain the proximity sensor, the display, the input device, the multimedia recorder, the mail transmitter and the processor that was previously discussed in FIG. 1.

FIG. 3 shows the steps of the processor of the information stand in a preferred embodiment of the invention.

In step 199, a method of said steps is started. Variables, flags, buffers, email body, recipient address, etc., are set to default states on the processor of the information stand. When the steps are started a second time on the processor, only corrupted variables, flags, buffers, e-mail body, recipient address, etc. are reset to default values by the processor.

In step 200, the user in the front of the information stand may be detected by means of the proximity sensor. The proximity sensor may be a movement sensor or the like. When the user is detected, the information stand may response with a played sound or with a flashing display. The information may currently play an audio file in a constant time frame to attract users to use the information stand.

In step 300, a user instruction on the display may be presented in response to the detection of the user by the proximity sensor. When the user is detected, the user instruction may also be presented on the display or the text of said user instruction may be played.

In step 400, the user may be prompted to confirm the user instruction presented by means of the display on the input device. After the playing or the presentation of said user instruction, the user may be prompted to confirm the received user instruction. The confirmation may be performed by means of pressing a field on a touch screen as a part of the display. The confirmation may also be performed by pressing a key on the input device, e.g. a on a keyboard. The confirmation may also take place by inserting money, swiping a credit card, entering an identification of the user such as a password or a digital code, recognizing a voice of the user, etc. By means of said insertion of money, the credit card, the entering of the user identification; the information stand may have an option to charge the user for its mail service. Said mail service, etc will be explained in step 700.

In step 500, the multimedia content may be recorded of the user by means of the multimedia recorder in response to the confirmation of the user instruction. When the user has confirmed the user instruction, the processor of the information stand may start a recording of multimedia content of the user. The multimedia content of the user may be a recorded voice or a recorded video clip of said user. As an option to the user, it may be possible for the user to have the multimedia clip played to him before he decides either to delete it or to keep it. In case of deletion, the processor of the information stand may give the user the option to record said clip again. When the user is pleased with the clip, he may finally approve it. The approval may take place by means of his voice, the pressing of a key on the keyboard or by the touching of the display. The information stand, i.e. the processor may record the clip in a certain predetermined amount of time, or the user himself may desire—by means of the input device—to determine a starting time and a stopping time (and thereby the duration) of said clip. During the recording of the video clip it may be compressed in real time by means of the processor to a smaller size (as originally recorded) in order to obtain a proper balance between the available Internet bandwidth and an achieved quality of the newly recorded, but compressed video clip.

In step 600, the user may be prompted to enter an e-mail recipient address and an own name. By means of the input means, i.e. the keyboard or the touch sensitive fields of the display, the user is asked by means of the prompt to enter said e-mail recipient address. In order to have a good user interface, the input means may, in particular, show an “at character”—i.e.@—in a bigger size than the other characters of the alphabet. It may further be possible by means of a spoken voice to enter the e-mail recipient address. The same input means and activities may also be performed, when the user enters his own name.

In step 700, the processor may generate an e-mail (109), wherein a body of the E-mail comprises a predetermined text, an attachment of the multimedia content recorded, said own name and a first link. Said first link may refer to a commercial site with promotional material. The predetermined text (which also are shown with three other underlined links) may comprise;

“Hello, a friend has send you a COMPANY v-mail from his ski resort. The video will be played when you double click on the attached file. The v-mail has been presented by COMPANY—probably the best after ski in the world, visit us on www.COMPANY.com. Have a nice day, For more information about v-mail go to www.v-mail.info. You need Windows Media Player to run this v-mail. If you do not have the Windows Media Player you can download it in 5 minutes at www.windowsmedia.com.”

Said COMPANY may be any company desiring to promote their products, good, services, etc, by means of a Web site on the Internet.

Additionally, the e-mail may comprise the wording “kind regards” or the like, and after that, said own name may be automatically added to the text.

The attachment of the multimedia content recorded may comprise the recorded content, which was discussed in step 500, i.e. the recorded voice or the recorded video.

When the multimedia content is a video clip, said video may be attached to the e-mail in a so-called mime encoded format.

The first link may—as shown in the above text—e.g. be www.COMPANY.com, i.e. said first link may thereby refer to a commercial site with promotional material.

The e-mail may further comprise—also as shown in the above text—another link to a Web site of the information stand, i.e. the link www.v-mail.info. Hereby a receiver, a user of a client computer, of the above mentioned mail may obtain information about the particular information stand, which was used to send said mail.

The e-mail may additionally comprise a second link to a second Web site, i.e. the link www.windowsmedia.com. Hereby the second link may link to a player for the multimedia content recorded. The link may be determined by the processor as a dedicated link dependent of the content clip recorded, i.e. the dedicated link may be one link for the sound clip and another different link for the video clip. Hereby, the recipient of the e-mail will be informed how to playback the content clip received.

In other words, in this step, the processor may generate the e-mail, which comprises said predetermined text, the attachment of the multimedia content recorded, the own name of the user and the first link, which may refer to—like the example given—to the commercial site of COMPANY. Additionally, a link to a dedicated player may be generated by the processor to the e-mail too.

In step 800, the E-mail body may be sent to the E-mail recipient address by means of the mail transmitter. In this step the combined information from the two foregoing steps is send by means of the mail body to the recipient address. Said E-mail body may be sent through a so-called SMTP protocol through a specified SMTP server to said recipient address.

Usually, the method will start all over again as long as the information stand with its build in proximity sensor, display, input device, multimedia recorder, mail transmitter and processor of the FIGS. 1 and 2 (where said steps are implemented and executed on the processor) is powered. Otherwise, the processor may terminate in step 900; however, when the information stand, etc., is powered again, the processor may proceed from step 200 again.

A computer readable medium may be magnetic tape, optical disc, digital video disk (DVD), compact disc (CD record-able or CD write-able), mini-disc, hard disk, floppy disk, smart card, PCMCIA card, etc.

1. An information stand with an automated e-mail generation (100) comprising a front (101), a proximity sensor (102), a display (103), an input device (104), a multimedia recorder (105) for recording multimedia content, a mail transmitter (106) and a processor (107), wherein the processor is coupled to the proximity sensor, the display, the input device, the multimedia recorder and where the processor is arranged to perform the following steps:
detecting (200) the user (108) in the front of the information stand by means of the proximity sensor;
presenting (300) a user instruction on the display in response to the detection of the user by the proximity sensor;
prompting (400) the user to confirm the user instruction presented by means of the display on the input device;
recording (500) the multimedia content of the user by means of the multimedia recorder in response to the confirmation of the user instruction;
prompting (600) the user to enter an e-mail recipient address and an own name;
generating (700) an e-mail (109), wherein a body of the E-mail comprises a predetermined text, an attachment of the multimedia content recorded, said own name and a first link, wherein the first link refers to a commercial site with promotional material; and
sending (800) the E-mail body to the E-mail recipient address by means of the mail transmitter.

2. An information stand according to 1, wherein the e-mail body further comprises a second link to a player for the multimedia content recorded, wherein the second link is determined by the processor dependent of said recorded content.

3. An information stand according to claim 1 or 2, wherein the multimedia content comprises a video clip.

4. An information stand according to claim 1 or 2, wherein the multimedia content comprises an audio clip.

5. A computer program product comprising program code means stored on a computer-readable medium for performing any one of claims 1 through 4 when the computer program is run on a computer.
